(19) United States
(12) Patent Application Publication
(10) Pub. No.: US 2005/0271826 A1
(43) Pub. Date: Dec. 8, 2005

(54) Film forming method, spacer utilizing the same and producing method for thin flat panel display

(75) Inventor: Kazuo Kuroda, Kamakura-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/139,554

(22) Filed: May 31, 2005

(30) Foreign Application Priority Data
Jun. 3, 2004 (JP) 2004-165562
May 16, 2005 (JP) 2005-142137

(51) Int. Cl. H05H 1/26; B05D 7/00; B05D 5/12

(52) U.S. Cl. 427/446; 427/421.1; 427/64

(57) ABSTRACT

The invention provides a method for inexpensively forming a uniform film of a uniform thickness on a substrate surface having fine concaves and convexes. On a substrate surface with concaves and convexes, having a spacing S between protrusion tops is 1 to 60 μm and a ratio (H/S) of a height H to the spacing S is 0.2 or larger, a precursor solution of an oxide is sprayed onto a heated substrate surface in an atomized state in which liquid droplets having a diameter d smaller than 0.8 times of the minimum spacing S on the concaves and convex surface are contained 80% or more in volume ratio.

### BACKGROUND OF THE INVENTION

1. Field of the Invention

The present invention relates to a film forming method with satisfactory film thickness control on a surface of a substrate having concaves and convexes, while maintaining such concave and convex shapes. In particular it relates to a film forming method by an spray thermal decomposition deposition on a substrate having concaves and convexes, and is to provide, utilizing such film forming method, a spacer for a thin flat panel display constituted of electron emitting devices and a producing method for a thin flat panel display.

2. Related Background Art

An field emission display (FED) is being recently researched and developed as a large-sized thin display of a small thickness. Such display achieves a light emission by accelerating electrons emitted from an electron emitting device and causing the electrons to collide with a fluorescent member, and is similar in principle to a cathode ray tube (CRT), but is featured, in contrast to the CRT, in basically having one or more electron emitting device for a pixel.

A vacuum envelope is required for producing a thin display in such system. There is generally employed a configuration of positioning two glass substrates in parallel state, providing one of mutually opposed surfaces with an electron source including plural electron emitting devices and wirings, and the other surface with fluorescent members, and sealing the two glass substrates for example across a frame member thereby maintaining vacuum in the interior thereof.

The vacuum envelope of such structure may be broken by an atmospheric pressure applied from the exterior. Therefore, a structure capable of withstanding the atmospheric pressure is obtained by forming a pressure-resistant structure, called a spacer, between the two glass substrates.

Such spacer, which may assume various shapes such as a plat shape, a cross shape, a cylindrical shape or a spherical shape, is basically required to have a sufficient mechanical strength and not to be easily charged. As the electron emitting devices are positioned in the vicinity of such spacer, it can be easily charged for example by an entry of electrons reflected from the surface of the fluorescent member, or by an electron emission from a triple junction. An eventual charging of the spacer may disturb an electron trajectory from the nearby electron emitting device, thereby deteriorating the image quality, or may cause a discharge phenomenon by a charging.

In order to prevent such phenomena, it is proposed to provide the surface of the spacer with an anti-charging resistance film (Japanese Patent Application Laid-open No. H08-007806) or to hinder the charging by providing the surface of the spacer with concave and convex shapes (U.S. Pat. No. 5,939,822). There is also proposed a method of forming an antistatic film on a substrate having concaves and convexes on the surface.

For forming a thin film such as the antistatic film as mentioned above, there are already known a vapor deposition method such as a CVD, a vacuum deposition such as sputtering, non vacuum and non vapor deposition such as a dipping, a spraying or a spin coating, and an spray thermal decomposition deposition method.

The vacuum deposition and vapor deposition often executed in a vacuum in a film forming chamber and thus requiring a large apparatus and a long film forming time, is inferior in productivity and cost to the non vacuum deposition. On the other hand, non vacuum film forming method represented by dipping or spraying, not requiring a large apparatus or a vacuum system and having a high film forming speed, shows a satisfactory productivity and is superior also in cost to the vacuum deposition method.

However, in the non vacuum film forming method, it is very difficult to obtain a uniform film on the surface of a substrate having concaves and convexes. Particularly in case of fine irregularities with a high aspect ratio of concave and convex, a uniform covering is difficult to achieve because of a capillary action. Therefore, non vacuum film forming method is employed in case of a film forming on a flat substrate, but is incapable of a precise film formation with a uniform thickness on a substrate having a surface with concaves and convexes.

It has thus not been possible to achieve a precise film formation in inexpensive manner on a substrate surface having fine concaves and convexes of a high aspect ratio. Therefore, it has not been possible, in a spacer as anti-pressure means of an image display apparatus utilizing a field emission, to inexpensively and uniformly form an antistatic film on a substrate surface having fine concaves and convexes.

### SUMMARY OF THE INVENTION

An object of the present invention is to provide a method for inexpensively forming a film of a uniform thickness on a substrate surface having concaves and convexes, also a method for producing a spacer of an image display apparatus utilizing such film forming method, and a producing method for an image display apparatus.

In a first aspect, the present invention provides a film forming method for forming an oxide film by a spray thermal decomposition deposition process on a substrate surface with concaves and convexes, on which a spacing S between protrusion tops is 1 to 60 μm and a ratio (H/S) of a height H to the spacing S is 0.2 or larger, the method being characterized in that a precursor solution of the oxide is sprayed onto a heated substrate surface in an atomized state in which liquid droplets having a diameter d smaller than 0.8 times of the minimum spacing S of the concaves and convexes surface are contained 80% or more in volume ratio.

In a second aspect, the present invention provides a method for producing a spacer to be positioned in an envelope of a thin flat panel display having such envelope, wherein the envelope includes a first substrate having an electron source provided with plural electron emitting devices and wirings for the electron emitting devices, a second substrate opposed to the first substrate and provided with a light emitting member which emits light by an irradiation with electrons emitted from the electron emitting devices, and a lateral wall intervened between the first substrate and the second substrate, and wherein the spacer is positioned between the first substrate and the second substrate and is constituted of a substrate having a surface with concaves and convexes on which a minimum spacing S between protrusion tops is 1 to 60 μm and a ratio of a height H to the spacing S is 0.2 or larger, and a high resistance film covering the surface of the substrate, the method being characterized in that the high resistance film is formed on the substrate surface by the film forming method of the first aspect.

In a third aspect, the present invention provides a method for producing a thin flat panel display having an envelope, including a first substrate having an electron source provided with plural electron emitting devices and wirings for the electron emitting devices, a second substrate opposed to the first substrate and provided with a light emitting member which emits light by an irradiation with electrons emitted from the electron emitting devices, a lateral wall intervened between the first substrate and the second substrate, and a spacer to be positioned between the first substrate and the second substrate, wherein the spacer is constituted of a substrate having a surface with concaves and convexes on which a minimum spacing S between protrusion tops is 1 to 60 μm and a ratio of a height H to the spacing S is 0.2 or larger, and a high resistance film covering the surface of the substrate, the method being characterized in that the spacer is produced by the producing method for the spacer of the second aspect.

In a fourth aspect, the present invention provides a method for producing a spacer, having concaves and convexes on a surface, to be positioned in an envelope of a thin flat panel display having such envelope, the method including:
a step of heating a substrate of a spacer having concaves and convexes on a surface; and
a step of forming a film by coating the heated substrate with a liquid containing a film material;
wherein the coating of the liquid containing the film material is executed by an ultrasonic atomizer.

### BRIEF DESCRIPTION OF THE DRAWINGS

FIG. 1 is a schematic view of a substrate surface in a spray thermal decomposition deposition method employed in the invention;

FIG. 2 is a schematic view of a spray thermal decomposition deposition method employed in the invention;

FIG. 3 is a schematic view showing a substrate temperature and a film forming mechanism in the spray thermal decomposition deposition method;

FIGS. 4A and 4B are schematic views showing a shape of a substrate employed in Example 1;

FIG. 5 is a schematic view of a spray thermal decomposition deposition system employed in Example 1;

FIG. 6 is a schematic view of a substrate forming step by the technique of heating and drawing glass;

FIGS. 7A and 7B are schematic views showing a shape of a substrate employed in Example 2;

FIG. 8 is a schematic plan view showing an electron emitting device constituting an image display apparatus of the invention;

FIG. 9 is a schematic perspective view showing a configuration of a display panel of an image display apparatus of the invention;

FIGS. 10A and 10B are charts showing waveform of a forming voltage employed in a producing method for an image display apparatus of the invention; and

FIG. 11 is a schematic view showing a cross-sectional shape of a substrate employed in Example 3.

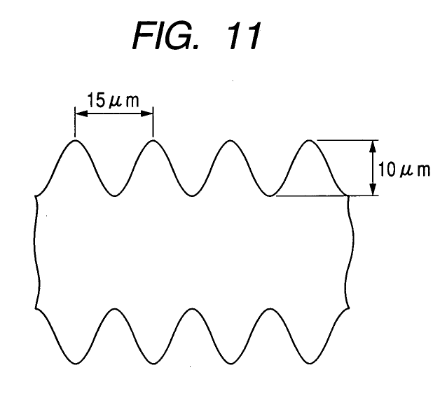

### DETAILED DESCRIPTION OF THE PREFERRED EMBODIMENTS

In the following, preferred embodiments of the present invention will be explained with reference to the accompanying drawings, but description of a dimension, a material, a shape and a relative position of components described in the embodiments is not to be construed as to limit the invention to such description, unless specified otherwise.

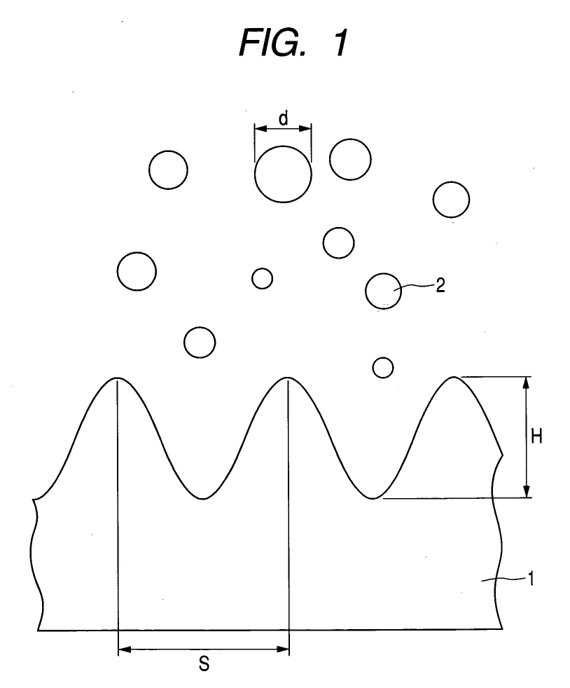

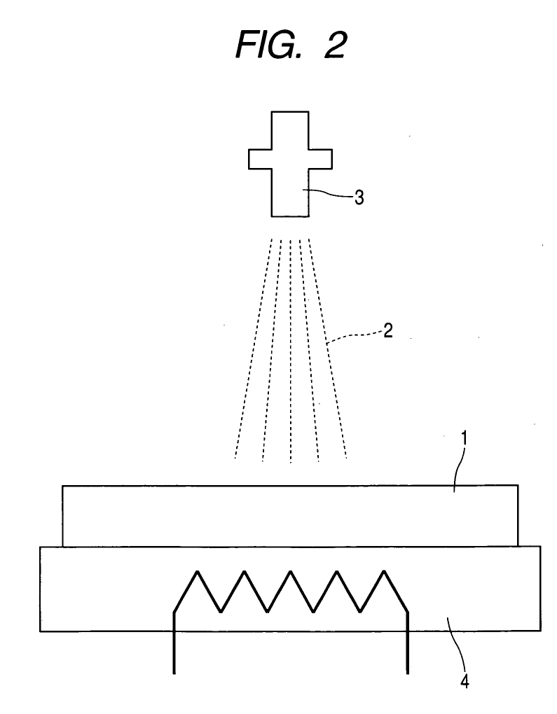

FIGS. 1 and 2 are schematic views of a spray thermal decomposition deposition method employed in film formation of the invention, wherein shown a substrate 1, a liquid droplet 2, a nozzle 3 and a heater 4.

In the spray thermal decomposition deposition method, as shown in FIG. 2, the substrate 1 to be subjected to the film formation is heated by the heater 4, and a solution containing an precursor of oxide is coated, from above by the nozzle 3 or another spraying means, as a fine liquid droplet 2 onto the surface of the substrate 1. The precursor of oxide deposited on the surface of the substrate 1 is subjected to thermal decomposition, thereby forming an oxide film on the surface of the substrate 1.

FIG. 1 is a view showing a relation between a surface structure of the substrate and a diameter of the liquid droplet, featuring the film forming method of the present invention.

The substrate 1 employed in the invention has concaves and convexes in at least a part of the surface, and such concaves and convexes have a minimum spacing S of protrusion tops of 1 to 60 μm and a ratio (H/S) of a height H and a spacing S of 0.2 or larger. FIG. 1 shows a structural example in which a surface shows a repeating sinusoidal changes in a concave-convex cross section.

The present invention is characterized in that the liquid droplets 2 of the solution containing the precursor are so formed that the liquid droplets 2 of a diameter d satisfying a relation d<S×0.8 for the aforementioned minimum spacing S of the protrusion tops represent 80% or more in a volume ratio, and, being subjected to a classification if necessary, sprayed onto the surface of the substrate 1.

Now the spray thermal decomposition deposition method will be briefly explained.

The spray thermal decomposition deposition (SPD) method is a film forming process capable of achieving a low cost and a film thickness controlling property. In this film forming method, a solution containing a precursor of an oxide (hereinafter called a precursor solution) is sprayed on a heated substrate to cause a growth of an oxide film on the substrate, thereby forming an oxide film. This method, being initially investigated as a method for forming a transparent conductive film of tin oxide on a glass substrate, is particularly advanced on the tin oxide film, and is capable, by employing a solution of tin chloride in water or alcohol as a precursor and by spraying the precursor solution by a spray or the like onto a glass substrate heated to about 300 to 500° C., of forming a uniform transparent conductive film of a large size at a high speed in an inexpensive manner.

However, even in such spray thermal decomposition deposition method, being based on spraying of liquid droplets, it is difficult to form a film of a uniform film thickness, on a substrate surface having concaves and convexes of a high aspect ratio, while maintaining such concave and convex shape. In the spray thermal decomposition deposition method, as a film tends to be formed from a portion of a higher probability of droplet deposition, there results a phenomenon, on concaves and convexes of a high aspect ratio, of a higher film growing speed on a convex and a smaller film thickness on a concave. Also in case the substrate surface has a recess, the coated surface does not become smooth but tends to become irregular. This is probably because of a mechanism that, when a liquid droplet is deposited in a concave portion, the liquid splashes for example by a bumping phenomenon and that the film forming condition is disturbed to deform the film as the concave portion has a temperature somewhat higher than in a protruding portion.

Therefore this method, though being expected for a low-cost film forming, is difficult to apply for coating the concaves and convexes of the substrate having fine concaves and convexes of a high aspect ratio.

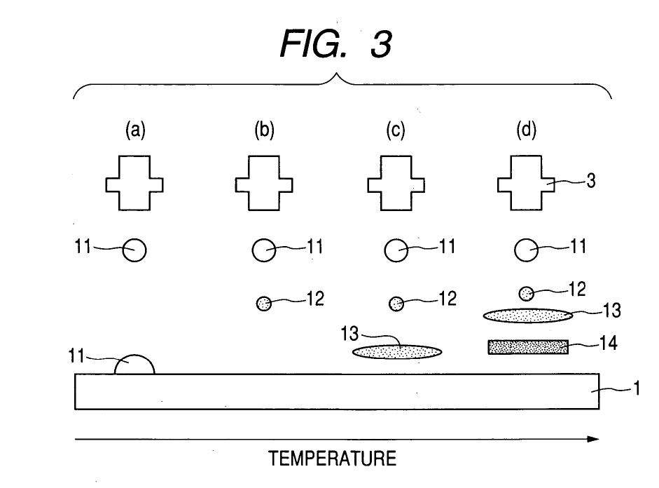

Now a temperature of the substrate 1 and a state of the liquid droplets in the spray thermal decomposition deposition method will be explained with reference to FIG. 3, in which (a) shows a state of a lowest substrate temperature, and (d) shows a state of a highest substrate temperature.

In a state shown in (a) of FIG. 3, an emitted liquid droplet 11 of a solution containing an precursor is deposited in such state onto the heated substrate 1 and forms a film. In such case, after the droplet 11 is deposited on the substrate 1, the solvent of the droplet 11 is evaporated and the precursor of oxide contained in the liquid droplet 11 is decomposed. Therefore, an inappropriate selection of solvent or an excessively large diameter of the liquid droplet may detrimentally affect the form of the film to be formed. For example the film may show a trace of the liquid droplet or may become rough by a rapid evaporation or combustion of the solvent. Particularly in case of a substrate with concaves and convexes, the solvent moves to a concave portion by a capillary action. Therefore, a rapid evaporation or combustion of the solvent is induced in such concave portion thereby facilitating a roughening of the film.

In (b) of FIG. 3, the substrate 1 has a temperature higher than in (a), whereby the liquid droplet 11 is subjected to a solvent evaporation before the landing and reaches the substrate 1 as a solid component (precursor) 12.

In (c) of FIG. 3, the substrate 1 has a temperature still higher than in (b), whereby the liquid droplet 11 is gasified through a state of the solid component 12, thus reaching the substrate 1 in a gaseous component 13 and causes a thermal decomposition on the substrate 1, thus realizing a mechanism similar to CVD.

In (d) of FIG. 3, the gaseous component 13 causes a thermal decomposition before reaching the substrate 1 and is deposited as oxide fine particles 14 onto the substrate 1.

In general, the mechanisms (a) to (d) do not proceed independently but take place in overlapping manner in film formation. Though variable depending on a material and a coating condition, a film principally formed by the mechanism (d) shows a rough surface state and cannot provide a precisely uniform film. This mechanism is not suitable for a case requiring a film of smoothness and uniformity of a high level, as in the antistatic film on the surface of the spacer for the field emission display.

Mechanisms (b) and (c) have a high possibility of providing a film with relatively good uniformity and smoothness. In practice, however, the mechanisms (b) and (c) take place in a coating condition of a very narrow range, and a coating operation aiming at such range inevitably involves the mechanism (d) and cannot be considered as a practical operation in consideration of a process margin.

In consideration of the foregoing, it is preferable, in the present invention, to select a condition in which the mechanism (a) takes place principally and the mechanisms (b) and (c) also proceed in parallel.

In practice, the substrate temperature is influenced by very complex parameters. It is difficult to determined by a calculational method as a distance between the substrate 1 and the nozzle 3, a spray amount, an evaluation heat of solvent, a solute concentration, a speed of sprayed particles and the like mutually influence in various manners. The substrate temperature is set at a decomposition temperature of the precursor or higher, but a temperature range thereabove is determined by executing an actual film forming operation.

For example, in case the film surface after film formation shows a large number of dust-like fine particles, the process (d) may probably be taking place and it is desirable to determine the process conditions so as to reduce the substrate temperature. Also in case a film is formed but is considered to have a rough surface under a SEM observation, the solvent may be causing a bump boiling on the substrate surface and a desirable result may be obtained by a change in the process conditions so as to elevate the substrate temperature. In this manner an actual coating operation is executed, and a film formation is conducted at a temperature capable of providing optimum film properties.

As explained above, the mechanism (a) results in a phenomenon that the liquid droplet 11 moves to a concave portion in case the substrate 1 has concaves and convexes, thereby often leading to a film insufficient in the surface smoothness and the uniformity. In order to avoid such phenomenon, the invention is characterized in controlling the droplet size distribution of the liquid droplet 11 thereby achieving a satisfactory film formation on the substrate with concaves and convexes even in a coating condition principally for the mechanism (a).

The film forming method of the invention, being capable of inexpensively forming an oxide film with a uniform film thickness and a uniform film quality on a substrate with fine concaves and convexes, is advantageously applicable to a method for producing a spacer of a thin flat panel display constituted for example with field emission electron emitting devices (the display being hereinafter also referred simply to as an image display apparatus), and to a producing method for an image display apparatus utilizing such spacer.

As explained in the foregoing, such spacer preferably has a form having an antistatic film on a substrate provided with fine concaves and convexes, and such antistatic film is required to have a surface smoothness, a uniformity and an ability of adapting to the surface concaves and convexes, of a very high level.

In case the antistatic film is insufficient in uniformity, namely involving a deviation in the composition, a distribution in electrical resistance is generated within the film. The spacer is given, at an upper end thereof, a voltage Va for accelerating electrons, and, at a lower end thereof, a low potential of the electron source (for example a GND potential), thereby generating a uniform electrical field in the vicinity of the spacer. Therefore, a distribution in the resistance of the antistatic film perturbs the electric field in the vicinity of the spacer, thereby disturbing a trajectory of the nearby flying electrons and deteriorating the image quality.

More specifically, the voltage applied between the upper and lower ends of the spacer may become as high as 10 kV or even higher, and, in case of application of such very high voltage, a very small protrusion eventually present on the spacer surface and not covered by the antistatic film easily induces a discharge or an electric filed emission. Therefore the film on the spacer surface is basically required to a surface following property equivalent to or higher than that of a sputtering method and a microscopic surface smoothness, and, in case of a film formation with the spray thermal decomposition deposition method in a condition involving a state as shown in (d) of FIG. 3, a probability of discharge becomes very high.

In case of forming the antistatic film on the spacer surface with the film forming method of the invention, there can be obtained an antistatic film excellent in a surface smoothness, a uniformity and a property following the surface concaves and convexes.

A substrate to be employed in the spacer producing method of the invention is usually glass. Also an precursor of oxide can be a metal- or Si-containing compound, preferably an ammonium salt, a chloride, a nitrate, an acetylacetonate (acac) complex, a DMP (dipivaloyl metanate) complex or a carboxylate salt thereof. Such compounds may be employed singly or in a combination of two or more kinds. Also a solvent of the solution containing the precursor can preferably be water, methanol, acetone, IPA (isopropyl alcohol) or methyl ethyl ketone, which may be employed singly or a mixture of two or more kinds in an arbitrary proportion.

Also a concave and convex structure on the substrate surface is preferably a structure in which linear convex stripes and linear concave stripes appear alternately, (ripple) and, there is preferred a shape in which, in a cross section of the spacer perpendicular to the stripes, the surface shows a sinusoidal wave shape or a rectangular wave shape.

In the film forming method of the invention, means which forms the liquid droplets is not particularly restricted but is preferably an ultrasonic nebulizer. Also if necessary, the droplets are further clarified by known classifying means to obtain a desired liquid droplet size distribution.

In the invention, the liquid droplet size distribution (volume distribution) is measured by a laser beam diffraction method.

In the invention, the liquid droplet size distribution was measured with LDSA-1400A utilizing the laser beam diffraction method, manufactured by Tonichi Computer Applications Co. The measurement was conducted with a lens of a focal length of 100 mm and a nebulizer positioned at 60 mm from the lens, under conditions of a BG (background (state before spraying)) fetch time of 2.0 seconds and an auto start function, and an average over 50 seconds was measured with averaging of 100 times and a fetching interval of 500 ms.

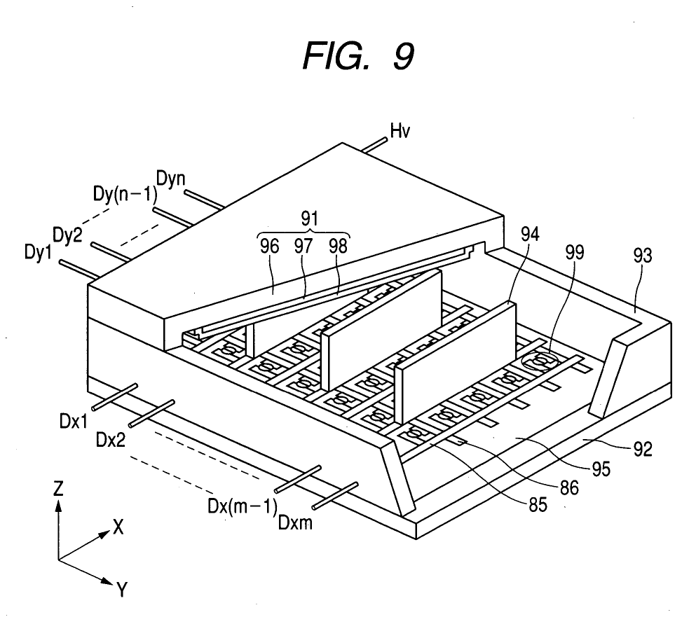

An example of the image display apparatus produced by the method of the invention is shown in FIG. 9, which is a perspective view of a display panel embodying the image display apparatus of the invention, with a part of the panel being cut off for showing the internal structure. A face plate 91 is formed by providing an internal surface of a glass substrate 96 with a fluorescent film 97 and a metal back 98. An electron source substrate 95 is provided with plural electron emitting devices 99, row wirings 85 and column wirings 86. There are also shown a rear plate 92 and a lateral wall 93, and an air-tight container is formed by the face plate 91, the rear plate 92 and the lateral wall 93 for maintaining the interior of the display panel in a vacuum state. For assembling the air-tight container, a sealing for maintaining a sufficient strength and an air-tight property is required in a junction of the components, and is achieved for example by coating frit glass in an adhering portion and calcining it for 10 minutes or more at 400 to 500° C. in the air or in a nitrogen atmosphere. Also as the interior of the air-tight container is maintained at a vacuum of about 10⁻⁴ Pa, a spacer 94 is provided as a pressure-resistant structure for preventing a destruction of the air-tight container under the atmospheric pressure or by an unexpected impact.

On the rear plate 92, there is fixed an electron source substrate 95 which is provided with electron emitting devices 99 in a number of n×m (n and m being positive integers equal to or larger than 2 and suitably selected according to the desired display pixel number, and selected, for example in a display apparatus for a high-quality television image display, preferably at n=3000 and m=1000 or larger). The electron emitting devices of a number of n×m are connected in a simple matrix by row wirings 85 of a number n and column wirings 86 of a number m. The electron emitting device 99 is not restricted in a material, a shape or a producing method thereof. Thus, there can be employed an surface conduction type electron emitting device or a cold cathode device of FE type or MIM type.

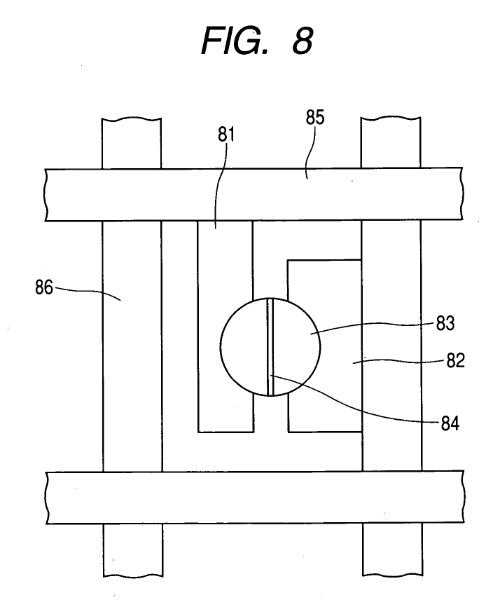

FIG. 8 is a schematic plan view of an electron emitting device 99 employed in the display panel shown in FIG. 9. There are shown device electrodes 81, 82, a conductive film 83 and an electron emitting portion 84. The electron emitting device of the present embodiment is of a surface conduction type and is connected in a simple matrix by a row wiring 85 and a column wiring 86. Under the row wiring 85, there is formed an interlayer insulation film (not shown) to achieve an electrical insulation from the column wiring 86.

The electron emitting device of the aforementioned structure is, after forming the row wiring 85, the column wiring 86, the interlayer insulating film (not shown), the device electrodes 81, 82 and the conductive film 83 on the substrate 95, subjected to an energization forming process and an energization activating process by energizing each device through the row wiring 85 and the column wiring 86, thereby completing the electron emitting device 84.

In the configuration shown in FIG. 9, the substrate 95 of the multiple electron sources is fixed to the rear plate 92 of the air-tight container, but the substrate 95 itself of the multiple electron sources, in case having a sufficient strength, may be employed as the rear plate 92 of the air-tight container.

Also on an internal surface of the face plate 91, there are provided a fluorescent film 97, and a metal back 98 which is already known in the filed of the cathode ray tube. The metal back 98 is provided for mirror reflecting a part of the light emitting by the fluorescent film 97 thereby increasing the efficiency of use of the use, for protecting the fluorescent film 97 from a collision of negative ions, for serving as an electrode for applying an electron beam accelerating voltage, and for serving as a conductive path for the electrons for exciting the fluorescent film 97. The metal back 98 is formed for example by vacuum evaporating aluminum, after the fluorescent film 96 is formed on the glass substrate 96 and the surface of the fluorescent film 96 is subjected to a smoothing process (called filming).

Also, though absent in the present embodiment, a transparent electrode for example constituted of ITO may be provided between the glass substrate 96 and the fluorescent film 97 for applying an accelerating voltage and for improving the conductivity of the fluorescent film.

### EXAMPLES

### Example 1

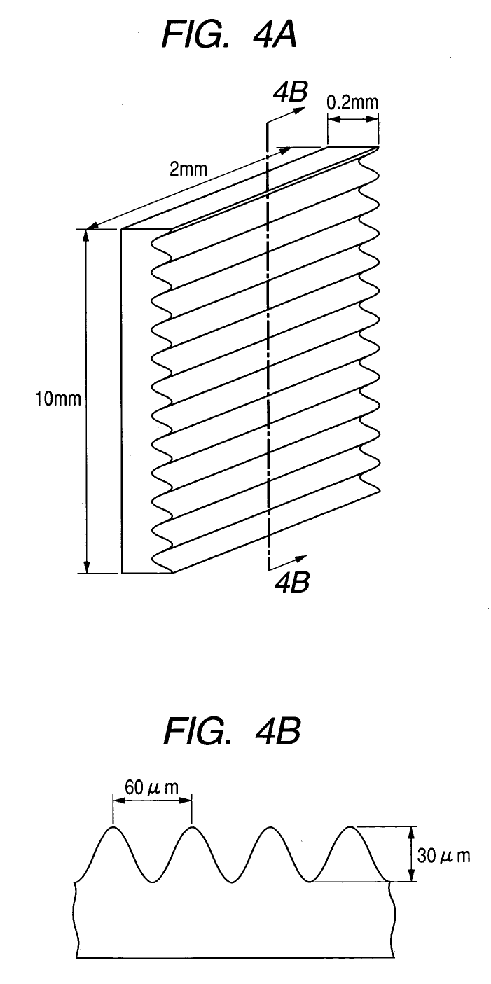

A soda lime glass was employed as a substrate, and concaves and convexes were formed by a glass molding method. FIG. 4A is a schematic perspective view showing the substrate employed in the present example, and FIG. 4B is a partial schematic cross-sectional view along a line 4B-4B in FIG. 4A. In the present example, concaves and convexes have a sinusoidal shape and are formed parallel to a shorter side of a rectangular substrate of 2 mm×10 mm×200 μm. The concaves and convexes have a minimum spacing S of the protrusion tops of 60 μm and a depth H of 30 μm.

The substrate 1 was placed flat on a heater 4 and was heated by the heater 4 so as to obtain a surface temperature of 450° C. The film formation was conducted to form a composite oxide film of Sn and Al, utilizing SnCl₄ and Al(acac)₃ as the precursors. Ethanol was employed as the solvent to prepare solutions respectively dissolving the precursors in 2 mass %.

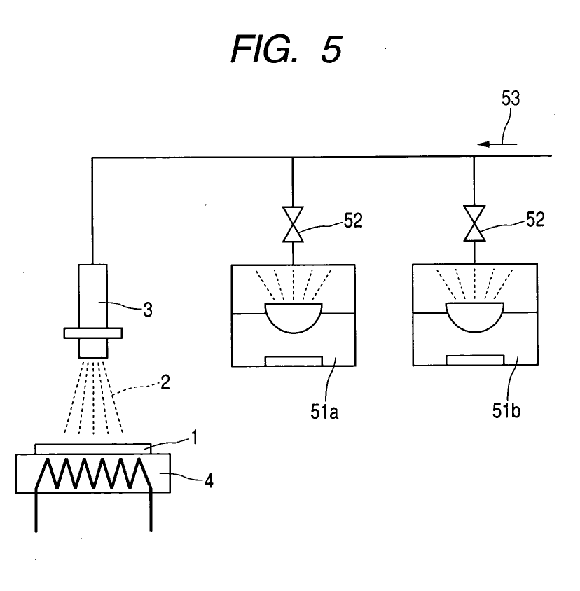

As means for generating liquid droplets, there was employed an ultrasonic spraying device (hereinafter also called an ultrasonic nebulizer). Two ultrasonic nebulizers were employed to atomize the respective solutions, and the liquid droplets thereof were mixed in the course and sprayed onto the substrate 1. FIG. 5 schematically shows a system including nebulizing units 51a, 51b, valves 52 and a carrier gas 53. The nebulizer employed an ultrasonic vibrator of 2.4 MHz and had a nebulizing power of 20 ml/min at maximum. There was employed a method of utilizing two nebulizing units 51a, 51b for nebulizing respectively different precursor solutions, which were carried by the carrier gas 53 and mixed in the course. An Sn/Al mixing ratio of the two precursors can be regulated by controlling the nebulizing amounts of the nebulizing units 51a, 51b, or by regulating the mixing ratio by the valves 52, or by regulating the concentrations of the precursors.

By a measurement of the size distribution of the liquid droplets emitted from the nozzle 3 of the ultrasonic nebulizer with the laser beam diffraction method, it was confirmed that the liquid droplets were distributed within a range of a size of 1 to 15 μm by 80 vol. % or more.

In the gas emitted from the nozzle 3, SnCl₄/EtOH was selected as 1 mass % and Al(acac)₃/EtOH was selected as 2 mass %. The valves 52 and the nebulizing rate were not particularly regulated, and the film formation was conducted with a maximum aperture and with a maximum rate. Heating of the substrate 1 was so regulated as to reach a surface temperature of 430° C. The spraying was conducted intermittently by a spraying for 2 minutes, then a pause for 30 seconds and a spraying for 2 minutes. The film formation was terminated when the spraying reached 10 minutes in total.

After the film forming operation, the film state on the substrate 1 was observed in detail.

An analysis of the film composition by EDAX (energy dispersion X-ray analysis) proved generation of a composite oxide film with an atomic ratio of Sn/Al=1:4.

Surface and cross-sectional observations by a high-resolution SEM (scanning electron microscope) confirmed formation of a smooth film of a microcrystalline state, without a deviation in composition, a trace of liquid droplet or other abnormality in the film state.

The cross-sectional SEM observation proved formation of a uniform film of a thickness of about 200 μm over the entire concaves and convexes.

### Comparative Example 1

A film formation was conducted with a substrate and materials same as those in Example 1, by a spray thermal decomposition deposition method under similar conditions with a two-fluid spray method. However, the precursor solutions were mixed in advance with a mass ratio 1:1. More specifically, a 1 mass % SnCl₄/EtOH solution and a 2 mass % Al(acac)₃/EtOH solution were mixed with a mass ratio of 1:1 to obtain an ethanol solution containing SnCl₄ by 0.5 mass % and Al(acac)₃ by 1 mass %. This solution was sprayed onto a substrate 1 (having a shape same as in Example 1) heated at 430° C. to form a film.

A measurement of the liquid droplet size distribution immediately after the emission from the spraying nozzle had a center value of the diameter of about 40 μm and a size distribution in which the liquid droplets of a diameter of 48 μm or larger represented about 35 vol. %.

The spraying was conducted by an intermittent method as in Example 1, by repeating 5 times an operation of a spraying for 2 minutes and a pause for 30 seconds. Thus formed film, observed similarly under a high-resolution SEM, showed a large number of traces of large liquid droplets exceeding 50 μm.

Also the results of cross-sectional observation by a high-resolution SEM proved following facts.

On a convex surface, an extremely thin single film of a thickness of about 20 nm was formed at first, and a substance such as amorphous oxide particles was deposited thereon with a considerable thickness. On the other hand, on a concave surface, a film of a uniform thickness was scarcely observed, but a substance such as amorphous oxide particles was deposited randomly with a thickness reaching almost half of the depth of the concave recess, depending on the location.

It is thus estimated, by spraying droplets exceeding a certain size on the surface having concaves and convexes, that at least a part of the droplets does not remain in the deposited position but moves to the convexes and cannot cause an appropriate film growth but induces an abnormality in the film property.

### Example 2

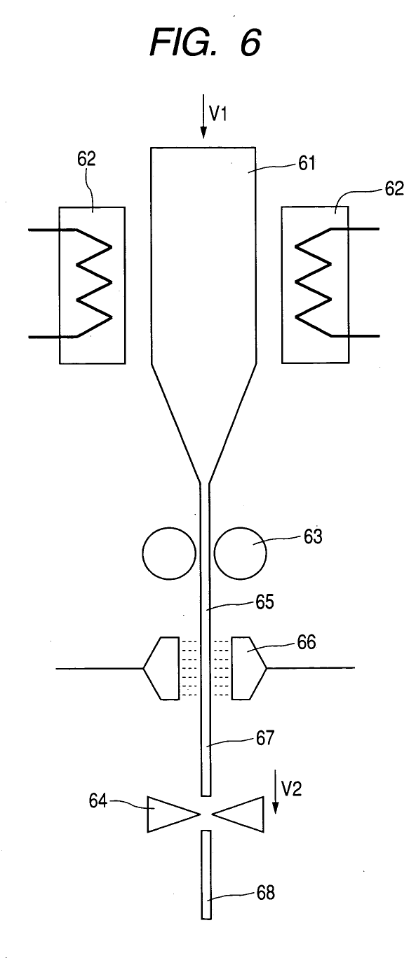

An image display apparatus of a structure shown in FIG. 9 was prepared. A substrate of the spacer 94 was prepared by the technique of heating and drawing, which will be explained with reference to FIG. 6, in which shown are a base material 61, a heater 62, a drawing roller 63, a cutter 64, extended members 65, 67, 68 and a nozzle 66.

In the technique of heating and drawing shown in FIG. 6, the base material 61 is heated by the heater 62. A heating temperature is variable depending on the base material, but is usually selected at 500° C. or higher in case of a glass. Thus the glass is molten and enables a drawing process. In the present example, there was employed a heating temperature of 750° C.

The molten glass was extended with the drawing rollers 63. A drawn glass of a cross section smaller than that of the base material 61 can be obtained by selecting a drawing speed V2 larger than a speed V1. Basically, the member 65 after drawing has a cross-sectional shape similar to that of the base material 61, and the member 65 after drawing has a cross section smaller than that of the base material 61 as the drawing speed becomes faster.

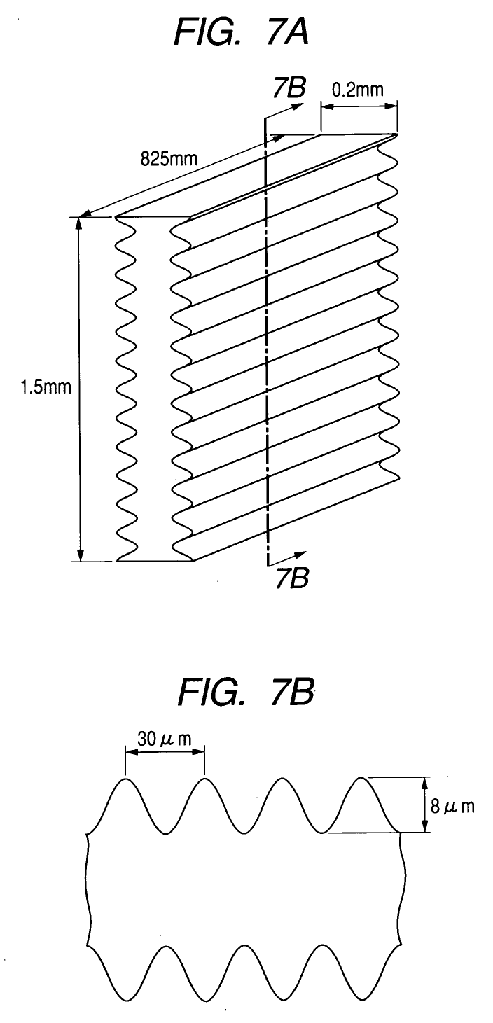

Also concaves and convexes can be formed on the surface of the member 65 after the drawing by providing the surface of the drawing rollers 63 with concaves and convexes. In the present example, the surface of the drawing rollers 63 is provided with concave and convex grooves to obtain concaves and convexes of a shape as shown in FIGS. 7A and 7B, on both surfaces of the member 65. The extended member 65 was cut by a cutter 64 into a member 68 of a finally necessary length. In the present example, the final member 68 was cut into a length of 825 mm.

The heated and drawn member 65 maintains a temperature of 500° C., and need not be reheated for executing the surface film formation by the spray thermal decomposition deposition method. In FIG. 6, a nozzle 66 is provided for spraying a solution containing an precursor of oxide onto the member 65 immediately after the heat drawing. The liquid droplet forming means can be, instead of a nozzle, a spray or a nebulizer. The present example employed an ultrasonic spray (ultrasonic nebulizer).

The detailed conditions for preparing the spacer are as follows.

A glass with a low Na content for an electron beam display was employed as the base material, which was heated at 750° C. and drawn at such a speed as to obtain a thickness of 200 μm and a width of 1.5 mm. The drawing rollers 63 were provided with concave and convex grooves to form longitudinal grooves on the surface of the member 65. The grooves formed on the surface of the member (substrate) 65 had concave and convex shapes with a minimum spacing S of protrusion tops of 30 μm and a depth H of 8 μm. The member 65 drawn into such shape was subjected to a film formation by the spray thermal decomposition deposition method utilizing the nozzle 66. In this state, the member 65 passing through the nozzle 66 maintained a temperature of about 520° C., suitable for the spray thermal decomposition deposition method.

As regards the conditions for spraying, a film to be formed was a composite oxide of Cr and Al (hereinafter represented as Cr—Al—O), and Cr(acac)₃ and Al(acac)₃ were employed as the precursors and were respectively dissolved in ethanol at a concentration of 1 mass %.

Then the Cr(acac)₃/EtOH solution and the Al(acac)₃/EtOH solution were mixed with a mass ratio of 4:1 to obtain a spray solution. A change in the mixing ratio allows to change Cr/Al ratio in the solution, thereby regulating the resistance. In the present example, an appropriate spade resistance could be obtained with an atomic ratio of Cr/Al≈3.7. The film had a specific resistivity of about 1×10⁷ Ω·cm.

The atomizing was conducted with a nebulizer employed in Example 1, with a center diameter of about 8 μm, a size distribution in which a size of 1 to 15 μm represented 80 vol. % and an atomizing ability of 20 ml/min. The feeding speed V2 of the member 65 was selected as 15 mm/.min. Under these conditions, a film of a thickness of about 200 μm was formed on the member 65.

The member 67 bearing the film was cut by the blade cutter 64 into a length of 825 mm to obtain a final member (spacer) 68.

Then thus obtained spacer was employed in preparing an image display apparatus of a structure shown in FIG. 9. The structure of the electron emitting device 99 was same as shown in FIGS. 8 and 9. The spacer having concaves and convexes, prepared as explained above, was employed as a spacer 94 shown in FIG. 9.

(Step 1)

A soda lime glass was employed as a substrate 95, which was washed with a detergent and purified water, and a pattern of the device electrodes 81, 82 was formed by a screen printing, utilizing a MOD paste (DU-2110, manufactured by Noritake Co.). The MOD paste contained gold as a metal component.

After the printing, the MOD paste was dried for 20 minutes at 110° C. and calcined in a heat treating apparatus under conditions of a peak temperature of 580° C. and a peak holding time of 8 minutes to obtain the device electrodes 81, 82 of a thickness of 0.3 μm. The device electrodes had a spacing of 10 μm.

(Step 2)

Then a paste material containing silver as a metal component (NP-4028A, manufactured by Noritake Co.) was screen printed in a pattern of column wirings 86 and was calcined under conditions similar to those in Example 1 to obtain column wirings 86.

(Step 3)

Then a paste containing PbO as a principal component was printed in a pattern of the interlayer insulation film, thereby obtaining an interlayer insulation film.

(Step 4)

Row wirings 85 were prepared in a similar manner as the column wirings 86 in the step 2.

(Step 5)

Then a conductive film 83 was formed. More specifically, a solution containing organic palladium was deposited by an ink jet emitting apparatus of a bubble jet system (trade mark) with a width of 200 μm, and then heated for 10 minutes at 350° C. to obtain a fine particle film constituted of fine particles of palladium oxide. Then the substrate 95 was subjected to an ultrasonic washing with a weak alkaline washing solution. The ultrasonic washing was conducted for 2 minutes with 0.4 mass % TMAH (trimethylammonium hydride) as the washing solution. After washing, it was rinsed for 5 minutes under running purified water, and, after elimination of the sticking water with an air knife, dried for 2 minutes at 120° C. in an oven.

Thereafter, the surface of the substrate 95 was coated with a resistance film by a following method.

The resistance film was formed employing fine oxide particles of tin oxide doped with antimony oxide, dispersed in a 1:1 mixture of ethanol and isopropanol. The solid had a concentration of about 0.1 mass %.

Coating was conducted by a spraying method. A spraying apparatus was employed with a liquid pressure of 0.025 MPa, an air pressure of 1.5 kg/cm², a substrate-head distance of 50 mm, and a head moving speed of 0.8 m/sec. After the coating, the film was stabilized by a calcining in the air for 20 minutes at 425° C.

After the substrate 95 was fixed on the rear plate 92, spacers 94 were maintained under a tension on both ends thereof, and positioned in 11 units at a constant pitch on the row wirings. Then the face plate 91 (having the fluorescent film 97 and the metal back 98 on the internal surface of the glass substrate 96) was placed on the lateral wall 93 and spacers 94 and the place plate 91, the lateral wall 93 and the rear plate 92 were sealed by coating frit glass on joint portions and sintering for 10 minutes in the air at 450° C.

The fixation of the substrate 95 onto the rear plate 92 was also conducted with frit glass.

The interior of thus completed glass envelope was evacuated with a vacuum pump through an evacuating pipe (not shown), and, after reaching a sufficient vacuum level, a voltage was applied between the electrodes 81, 82 of the electron emitting device 99 through external terminals Dx1 to Dxm and Dy1 to Dyn to execute a forming process on the conductive film 83, thereby forming the electron emitting portion 84.

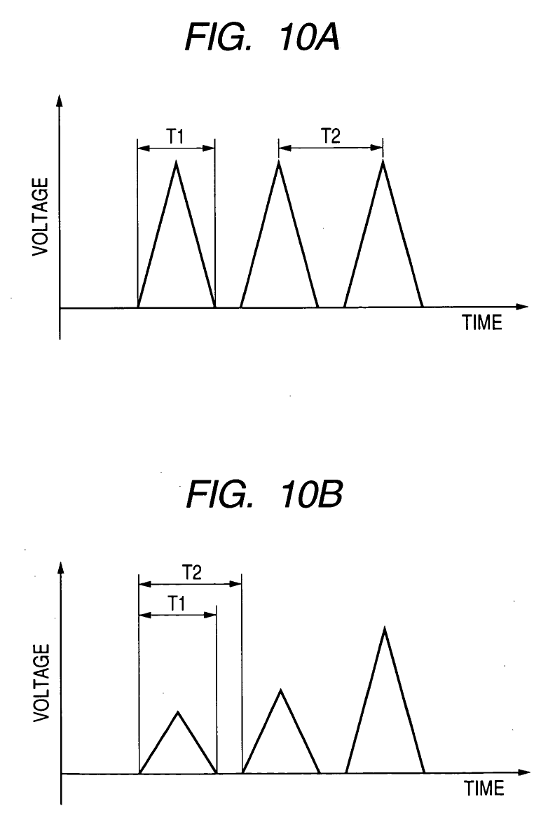

The forming process was conducted with a voltage wave form as shown in FIG. 10B. In the present example, the process was conducted under a pressure of about 2×10⁻³ Pa, with T1 of 1 msec and T2 of 10 msec. It is also possible to employ the voltage wave form shown in FIG. 10A.

The electron emitting portion 94 thus formed had a state in which fine particles principally formed by palladium element were dispersed, and had an average particle size of 3 nm.

Then acetone was introduced into the display panel through a slow leak valve and the evacuating pipe of the panel and was maintain at 0.1 Pa. Then an activation process was conducted by changing the triangular wave, employed in the forming process, into a rectangular wave with a wave height of 14 V and under a measurement of a device current If (current between the device electrodes 81, 82) and an emission current Ie (current reaching anode (metal back 98)).

The electron emitting portion was formed and the electron emitting device 99 was prepared through the forming process and the activation process explained above.

Then the glass envelope was evacuated to a pressure of about 10⁻⁴ Pa, and was sealed by heating and fusing the unillustrated evacuating tube with a gas burner.

Finally, in order to maintain the vacuum after the sealing, a getter process was executed with a high frequency heating method.

In thus completed image display apparatus of the example, the electron emitting devices 99 were given scanning signals and modulation signals from unillustrated signal generating means through the external terminals Dx1 to Dxm and Dy1 to Dyn to cause electron emissions and a high voltage of Va=10 kV or higher was applied through a high voltage terminal Hv to the metal back 98 to accelerate the electron beams thereby causing collision with the fluorescent film 97 to induce excitation and light emission whereby an image was displayed.

As a result, a stable image display of a high quality was obtained without a deflection of electron beams or a breakage by a discharge. Also in the vicinity of the spacer 94, there was not generated a perturbation in the electron arriving position (light emitting position), different from other areas, and a fixed pattern presumably resulting from the spacer 94 was not observed at all.

Thereafter the image display apparatus was disassembled and the spacer 94 was observed with a high-resolution SEM. It was confirmed that a uniform film of a thickness of about 200 nm was formed on concaves and convexes and that the surface was free from fine irregularities or abnormal growth and also microscopically had a smoothness and a cleanness comparable with those of the sputtering method.

### Comparative Example 2

An image display apparatus was prepared in the same manner as in Example 2, except that the vibrator of the nebulizer for atomizing the precursor in the film formation by the spray thermal decomposition deposition method shown in FIG. 6 was changed to obtain a different distribution of the size of the liquid droplets. In the nebulizer of the present example, the liquid droplets had a center size of about 25 μm and a volume ratio of about 65% being represented by the droplets of a size of 24 μm or larger.

In the image display apparatus of the present example, when a high voltage Va was applied to the metal back 98 through the high voltage terminal Hv, there was confirmed, at a voltage application of about 7 kV, a small point-shaped light emission from the spacer 94. It was also confirmed that the light emission increased the luminance with an increase in the accelerating voltage Va.

Then, when an image display was executed by supplying the electron emitting devices 99 with signal currents and scanning currents thereby causing electron emissions at Va=10 kV, a large discharge was induced from the vicinity of the point-shaped light emission of the spacer 94 within several minutes, and the electron emitting devices in the vicinity were destructed whereby the image display could not be obtained thereafter around the spacer.

The image display apparatus was then turned off and disassembled, and the spacer 94 was observed under the high-resolution SEM. As a result, the spacer 94 had a smooth surface showing formation of a uniform film, but, in comparison with the surface of the spacer of Example 1, there were discovered a few portions showing a disturbed irregular surface. The small point-shaped light emission generated from the vicinity of the spacer 94 is estimated to result from a field emission from such few irregularities under a high voltage.

Also such point-shaped light emission is considered to have induced a charging of the spacer 94, and have resulted in a final discharge by an increase of the spacer charge at the image display.

### Example 3

The substrate surface of the spacer had concaves and convexes of a minimum spacing S of ptotrusion tops of 15 μm and a depth H of 10 μM. This was obtained by changing a shape of a groove forming blade provided on the drawing rollers 63 shown in FIG. 6.

The spray means employed in the spray thermal decomposition deposition method was same as that in Example 2, and the sprayed liquid droplets had a center diameter of about 8 μm and a size distribution in which a size of 1 to 15 μm represented 80 vol. %. In the present example, the liquid droplets were classified by passing a mesh having fine holes to obtain droplets having a center size of about 7 μm and a distribution in which a size of 1 to 10 μm represented 80 vol. % of all the droplets.

The feeding speed by the drawing rollers 63 was selected as 11 mm/min, and a uniform Cr—Al—O film of a thickness of 200 nm was formed on the member 65 under such condition. The specific resistivity was 1×10⁷ Ω·cm as in Example 2.

Thereafter, an image display apparatus was prepared in the same manner as in Example 2, and an image display was conducted at Va=10 kV. There was displayed a stable image of a high quality, without a deviation of an electron beam or a destruction by a discharge. Also in the vicinity of the spacer 94, there was not generated a perturbation in the electron arriving position (light emitting position), different from other areas, and a distorted pattern presumably resulting from the spacer 94 was not observed at all.

Thereafter the image display apparatus was disassembled and the spacer 94 was observed with a high-resolution SEM. It was confirmed that a uniform film of a thickness of about 200 nm was formed on concaves and convexes and that the surface was free from fine irregularities or abnormal growth and also microscopically had a smoothness and a cleanness comparable with those of the sputtering method.

### Comparative Example 3

An image display apparatus was prepared in the same manner as in Example 3 except that, in the preparation of the spacer 94, the liquid droplets generated in the nebulizer were not classified through the mesh but sprayed directly (with a central size of about 8 μm, a size distribution in which a size of 1 to 15 μm represented 80 vol. % and a size of 12 μm or larger represented 40 vol. % or more).

As a result, a small point-shaped light emission was generated from about Va=7 kV as Comparative Example 2, and, in an image display with Va elevated to about 10 kV, a discharge occurred within several minutes and an image display of a high quality became impossible.

The image display apparatus was then disassembled, and the spacer 94 was observed under the high-resolution SEM. As a result, the spacer 94 showed a formation of a smooth and defect-free film over the almost entire area, but the smooth surface was disturbed slightly and showed irregularities in a few positions.

Such surface irregularities of the spacer 94 was estimated as the cause of the discharge.

According to the film forming method of the invention, an inexpensive spray thermal decomposition deposition method of a high productivity can be employed to form a uniform oxide film even on the surface of the substrate having fine concaves and convexes. Thus, such film forming method allows, in an image display apparatus utilizing electron emitting devices, to form an antistatic film of a high surface smoothness with a uniform thickness on a substrate having fine concaves and convexes on the surface, without generating a shape detrimentally affecting the surface smoothness such as a capillary action or a trace of liquid droplet, thereby obtaining a spacer protected from an influence of charging and realizing an image display of a high image quality utilizing such spacer.

This application claims priority from Japanese Patent Application No. 2004-165562 filed Jun. 3, 2004, which is hereby incorporated by reference herein.

1. A film forming method for forming an oxide film by an spray thermal decomposition deposition process on a substrate surface with concaves and convexes, on which a minimum spacing S between protrusion tops is 1 to 60 μm and a ratio (H/S) of a height H to the spacing S is 0.2 or larger, wherein a precursor solution of the oxide is sprayed onto a heated substrate surface in an atomized state in which liquid droplets having a diameter d smaller than 0.8 times of the minimum spacing S of the concaves and convex surface are contained 80% or more in volume ratio.

2. A film forming method according to claim 1, wherein means for forming the liquid droplets is an ultrasonic atomizer.

3. A film forming method according to claim 1, wherein the liquid droplets produced by liquid droplet forming means are classified and then applied to the substrate surface.

4. A film forming method according to claim 1, wherein the concaves and convexes have a shape formed by repeating a linear concave stripe and a linear convex stripe and the substrate has a sinusoidal or rectangular wave form in a cross section in a direction perpendicular to the stripes.

5. A film forming method according to claim 1, wherein a solvent of a precursor solution of the oxide employed in the film forming method is water, methanol, ethanol, acetone, isopropyl alcohol, or methyl ethyl ketone, or a mixture of two or more thereof.

6. A film forming method according to claim 1, wherein a precursor of the oxide employed in the film forming method is a metal- or Si-containing compound, or two or more thereof.

7. A film forming method according to claim 6, wherein the precursor of the oxide is an ammonium salt, a chloride, a nitrate salt, an acetylacetonate complex, a DMP complex, or a carboxylate salt.

8. A producing method for a spacer to be positioned in an envelope of a thin flat panel display having such envelope, in which the envelope includes a first substrate having an electron source provided with plural electron emitting devices and wirings for the electron emitting devices, a second substrate opposed to the first substrate, and provided with a light emitting member which emits light by an irradiation with electrons emitted from the electron emitting devices, and a lateral wall intervened between the first substrate and the second substrate, and in which the spacer is positioned between the first substrate and the second substrate and is constituted of a substrate having a surface with concaves and convexes on which a minimum spacing S between protrusion tops is 1 to 60 μm and a ratio of a height H to a spacing S is 0.2 or larger, and a resistance film covering the surface of the substrate, wherein:
the resistance film is formed on the substrate surface by the film forming method according to claim 1.

9. A producing method for a thin flat panel display having an envelope, including a first substrate having an electron source provided with plural electron emitting devices and wirings for the electron emitting devices, a second substrate opposed to the first substrate and provided with a light emitting member which emits light by an irradiation with electrons emitted from the electron emitting devices, a lateral wall intervened between the first substrate and the second substrate, and a spacer to be positioned between the first substrate and the second substrate, wherein
the spacer is constituted of a substrate having a surface with concaves and convexes of a minimum spacing S between protrusion tops is 1 to 60 μm and a ratio of a height H to the spacing S is 0.2 or larger, and a resistance film covering the surface of the substrate, and the spacer is produced by the producing method for the spacer according to claim 9.

10. A producing method for a spacer, having concaves and convexes on a surface, to be positioned in an envelope of a thin flat panel display having such envelope, the method comprising:
a step of heating a substrate of a spacer having concaves and convexes on a surface; and
a step of forming a film by coating the heated substrate with a liquid containing a film material;
wherein the coating of the liquid containing the film material is executed by an ultrasonic atomizer.
